(19) United States
(12) Patent Application Publication
(10) Pub. No.: US 2007/0157316 A1
(43) Pub. Date: Jul. 5, 2007

(54) Managing rogue IP traffic in a global enterprise

(75) Inventors: Steve Devereux, Folsom, CA (US); Rodney B. Rubert, Rescue, CA (US); Timothy Verrall, Pleasant Hill, CA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(73) Assignee: Intel Corporation

(21) Appl. No.: 11/322,825

(22) Filed: Dec. 30, 2005

(51) Int. Cl. G06F 12/14

(52) U.S. Cl. 726/24

(57) ABSTRACT

Methods, apparatuses, articles of manufacture, and systems for receiving a plurality of data packets, analyzing the packets to determine whether each of the packets should be considered legitimate or illegitimate, and routing the legitimate packets to their destinations at a first one or more routing rates, and re-routing the illegitimate packets to one or more special destinations for further analysis or disposition at a second one or more routing rates that are lower than the first one or more routing rates, are described herein.

### TECHNICAL FIELD

Embodiments relate to the field of data processing, in particular, to methods and apparatuses for receiving, analyzing and routing data packets.

### BACKGROUND

Continuous advancements in the speed of processors, system memory, routers, networking, and client/server architecture have led to the development of global public networks such as the Internet and global private networks such as enterprise wide area networks (WANs) of increasing speed and usefulness. Concomitant with these advancements, numerous threats, such as worms, viruses, and distributed denial of service (DDOS) attacks, making use of the same advancements, have also arisen. These threats have targeted public and private networks, and the computers connected to and through them. Further, they have taken advantage of the enhanced connectivity to reach a massive number of computer systems, targeting each and every system in an enterprise or on the Internet. The threats have also targeted the networks themselves, causing lost connectivity, and consequently, lost productivity, for substantial periods of time.

Numerous solutions have been advanced to counter the threats to computer systems and networks. Typically, the computer systems themselves are protected by any one of many commonly available computer security programs, such as Norton Antivirus or McAfee. These programs detect and isolate threats received from Internet or some other network. Further, networks such as WANS or local area networks (LANs) are typically protected by “Firewall” software capable of monitoring traffic across a network and blocking any suspect traffic. Firewalls, however, are limited in their ability to counter threats in their earliest stages, before the traffic has been identified to be a threat.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention;

FIG. 2 illustrates a flow chart view of selected operations of the methods of various embodiments of the present invention;

FIG. 3 illustrates a system view of embodiments of the present invention, the system having a backup battery pack coupled to selected one or ones of the computing devices and router; and

FIG. 4 illustrates an example router suitable for use to practice various embodiments of the present invention.

### DETAILED DESCRIPTION OF ILLUSTRATIVE EMBODIMENTS

Illustrative embodiments of the present invention include, but are not limited to, methods and apparatuses for receiving a plurality of data packets from one or more computing environments, analyzing the packets to determine whether each of the packets should be considered legitimate or illegitimate, and routing the legitimate packets to their destinations at a first one or more routing rates, and re-routing the illegitimate packets to one or more special destinations for further analysis or disposition at a second one or more routing rates that are lower than the first one or more routing rates, are described herein.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

The terms “legitimate” and “illegitimate” are used repeatedly to describe received data packets. In various embodiments, what is considered legitimate or illegitimate may vary from application to application depending on the balance of importance between consistently transmitting legitimate packets (i.e., when in doubt as to whether a packet is illegitimate, classify it as legitimate) and detecting and containing all potential threats (i.e., when in doubt as to whether a packet is illegitimate, classify it as illegitimate). In some embodiments, all packets having a destination that can be found on an access list of valid destinations (valid as determined by the enterprise of which the WAN router making the determination is a part) will be considered legitimate, and all packets not having a destination on that list will be considered illegitimate.

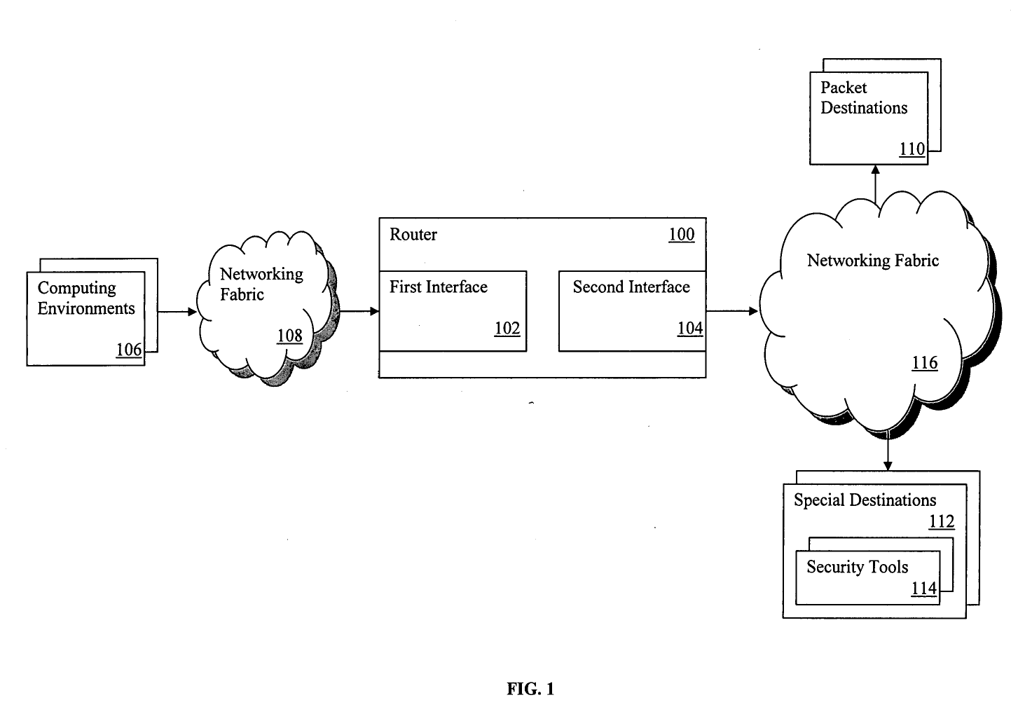

FIG. 1 illustrates an overview of various embodiments of the present invention. As illustrated, router 100 has a first one or more interfaces 102 and a second one or more interfaces 104. In other embodiments, however, router 100 may have any number of interfaces for receiving and routing data packets. Further, router 100 may be any sort of router commonly known in the art. Though depicted here as a WAN router capable of receiving packets from a LAN and routing the packets across a WAN, router 100 may also be implemented as a LAN router receiving packets from various computing environments and routing those packets to various other computing environments and/or to the Internet, and/or to a WAN router to be routed across a WAN.

Further, as used herein, a “router” is any one or more computer systems capable of receiving, analyzing, and routing/re-routing a plurality of data packets. As illustrated, router 100 has a plurality of interfaces to receive and route packets, and a routing process linking the interfaces and directing received packets from one appropriate interface to another. In various embodiments, first interface 102 and second interface 104 may be ports providing connections between the router 100 and networks such as networking fabric 108 and networking fabric 116. These ports may be capable of sending and receiving packets to and from such networking fabrics.

As is further illustrated, the first one or more interfaces 102 of router 100 may receive a plurality of data packets from one or more computing environments 106 through a networking fabric 108. In some embodiments, computing environments 106 may be connected to each other via a LAN router, and send and receive packets to and from router 100 via that LAN router. In such embodiments, router 100 may serve as a WAN router for computing environments 106, providing computing environments 106 with connectivity to the WAN. Also, in such embodiments, networking fabric 108 may be a LAN, having a LAN router connecting the computing environments 106 to each other and to router 106. As mentioned above, in various embodiments, router 100 may itself be a LAN router connecting the computing environments 106 and routing/re-routing packets to a WAN router to be routed/re-routed across a WAN.

In yet other embodiments, computing environments 106 may be connected directly to router 100 through networking fabric 108 and need not be connected to each other via a LAN router. In such embodiments, computing environments 106 are not part of a LAN, but may be part of the same WAN, connected by router 100. Rather than being part of a WAN, computing environments 106 may also simply be connected to the Internet or some other public network via router 100.

In various embodiments, computing environments 106 may be any sort of computing devices known in the art, such as PCs (personal computers), workstations, servers, embedded systems, mobile phones, or PDAs (personal digital assistants), among many others. A computing environment 106 may be connected to other computing environments 106 via a LAN, a WAN, the Internet, or some other public network. As illustrated here, computing environments 106 are connected to each other via a LAN, shown as networking fabric 108, and connected to an enterprise WAN via router 100. These LAN, WAN, and/or other networks may be implemented through TCP/IP (Transmission Control Protocol/Internet Protocol) connections, or in other embodiments, may be implemented as any other sort of connection known in the art. Computing environments 106 may send a plurality of data packets to router 100, and some of these data packets may be one or more modules of malicious programming instructions designed to negatively impact computer systems and/or networks. Such modules may consist of a worm, a virus, and/or a distributed denial of service attack. The modules may also consist of any other sort of computer security threat known in the art. These modules may cause computer systems to crash (i.e., shut down without input to do so from a user) or alter normal operations by using up resources, such as system memory, of the computer system. They may also flood a network with a volume of traffic that overwhelms the network, causing the routers of the network to either crash or perform routing operations at a substantially reduced speed. The modules may also produce a host of other negative effects upon computer systems and networks, the host of other effects being well known in the art.

As described above, router 100 has a first one or more interfaces 102. In various embodiments, first interface 102 receives a plurality of data packets from computing environments 106 via networking fabric 108. As described above, in some embodiments, first interface 102 may be a port providing connectivity between router 100 and networking fabric 108. Upon receiving the plurality of data packets, logic of first interface 102 proceeds to analyze each of the received packets to determine whether each packet is legitimate or illegitimate, the meaning of those terms defined above. In some embodiments, the analysis comprises comparing each of the packets to a list of legitimate destinations maintained by the router 100. The list of legitimate destinations, referred to in various embodiments as an “access list,” may contain all addresses within a global enterprise WAN to which packets may be routed. The list may in other embodiments, however, contain, less, more, or different addresses to which packets may be sent. As referred to in this series of embodiments, an “address” is a unique identifying value for every router and computing device having access to a network. This address may be the same as the IP (Internet Protocol) address commonly used to identify computers on a LAN, a WAN, or the Internet, or may be some other address. As shown here, the list of legitimate destinations contains addresses for computing devices connected to an enterprise WAN, either directly or through a WAN router such as router 100. Packets having as a destination address an address contained by the list, may, in some embodiments be considered legitimate, while those having a destination address not contained by the list may be considered illegitimate. In other embodiments not shown, first interface 102, may, as part of the comparison, determine if the addresses of the list share an address space (for purposes of this series of embodiments, an address space may be understood as a portion of the address value that is the same for all addresses of a specific group). For example, all addresses on the list of legitimate destinations may share “179” as part of their address values (e.g., 179.010.345.002). If some or all of the addresses on the list share an address space, and first interface 102 receives a packet sharing that address space but not on the list, first interface 102 may consider the packet either legitimate or illegitimate, based on preferences such as those discussed above. Further, in some embodiments comparison to the list may be facilitated by associating the list with a routing class map, associating the routing class map with an IP marking policy map, and then applying the IP marking policy map to the received packets at first interface 102.

As is further illustrated, first interface 102 may then mark and rate-limit packets considered illegitimate. Such packets may be “marked” by setting an IP DSCP (differentiated services code point) value of each packet in that packet's header. A packet header is understood to have the meaning here as it is commonly understood in the art (i.e., a header is a portion of the packet having the packet's destination and origination addresses, as well as information instructing routers how to handle the packet). For example, if the illegitimate packet had its DSCP value set for high priority services, first interface 102 may reset the DSCP to a different, specified value, the that value being recognized by router services as requesting re-routing to special destinations 112 at a lower routing rate. In some embodiments, this may simply involve changing the DSCP to request lower priority services from routers. In this way, transmission of illegitimate packets may be rate limited to a maximum bandwidth.

After “marking” illegitimate packets by, in some embodiments, resetting their DSCP values, first interface 102 may then send the illegitimate packets to a routing process of router 100, where the packets may follow the default routing path to the second one or more interfaces 104 for transmission.

As is also illustrated, if one or more data packets of the received plurality of packets are determined to be legitimate, first interface 102 may immediately send the packets determined to be legitimate to the routing process of router 100, where the packets may follow the default routing path to the second one or more interfaces 104 for transmission.

The operations performed by the first interface 102 in some embodiments, described above, need not be performed in the same order or combination. In some embodiments, fewer of these operations may be performed, while in other embodiments, additional packet receiving and analyzing operations, such as those known in the art, may be performed.

As illustrated, second one or more interfaces 104 of router 100 may receive both legitimate and illegitimate packets via the default routing path of the routing process of router 100. Upon receiving the packets, second interface 104 may route the legitimate packets to their destinations 110 across a networking fabric 116 (as shown, an enterprise WAN), and may re-route at least some of the illegitimate packets to one or more special destinations 112. As shown here, the one or more special destinations may be a secure sub-network having a plurality of security tools 114 to analyze the illegitimate packets. As described above, second interface 104 may be a port of router 100 providing connectivity between router 100 and a networking fabric 116, such as an enterprise WAN. In other embodiments, second interface 104 may comprise a multiplicity of ports, some for routing legitimate packets to their destinations, others for re-routing illegitimate packets to one or more special destinations 112.

Upon receiving packets, second interface 104 may route legitimate packets to their destinations 110. In doing so, second interface 104 may first ascertain the legitimacy of the packets by reading the packets' DSCP values. If the values are set to the specified value mentioned above, they may be re-routed as illegitimate packets. If on the other hand the DSCP value of the packets differs from the specified value, the packets may be routed to their destinations 110 through networking fabric 116, an enterprise WAN as shown here. In various embodiments, however, second interface 104 need not check the DSCP value of the packets to ascertain their legitimacy or route them to their destinations 110. As suggested above, second one or more interfaces 104 may have multiple interfaces, some of which exclusively route legitimate packets to their destinations. In such embodiments, no ascertainment of legitimacy on the part of second one or more interfaces 104 need be made. In either series of embodiments, however, legitimate packets may be routed to their destinations 110 at a higher one or more routing rates than illegitimate packets are re-routed to their one or more special destinations 112. In some embodiments, this may consist simply of routing the legitimate packets at the routing rate commonly used by router 100 in routing packets. The second one or more routing rates at which illegitimate packets are re-routed may consist of some maximum bandwidth, such as ten packets per second.

Further, in various embodiments, second interface 104 re-routes illegitimate packets to one or more special destinations 112 for analysis or disposition. As described above, second interface 104 may first ascertain the legitimacy of the packets by reading their DSCP values. Illegitimate packets may have been marked as such by the first interface 102, first interface 102 having set the DSCP value of the illegitimate packets to a specified value, such as the value commonly used to request lower priority services from routers. Also, as described above, in some embodiments second one or more interfaces 104 need not ascertain the legitimacy of the packets because second one or more interfaces 104 may have separate interfaces for routing legitimate packets and re-routing illegitimate packets. In either series of embodiments, upon receipt and/or ascertainment of illegitimate packets, those packets may be re-routed to one or more special destinations 112 for analysis or disposition at a second one or more routing rates that is lower than the first one or more routing rates at which legitimate packets may have been routed. In some embodiments, this second one or more routing rates may consist of a maximum bandwidth value, such as ten packets per second. In re-routing the illegitimate packets, second interface 104 may reset the destination address of the packets' contained in the packets' headers to an address of the one or more special destinations 112. By resetting the destination address of the illegitimate packets, second interface 104 allows the illegitimate packets to be sent through intermediate, relaying routers of the networking fabric 116 to the one or more special destinations 112. In various embodiments, however, second interface 104 need not reset the destination address of the illegitimate packets in sending them to their special destinations 112. Instead, second interface 104 may simply establish a connection to the special destinations across the networking fabric 116, sending the illegitimate packets directly to the special destinations 112. In some embodiments, second interface 104 need not re-route all illegitimate packets. Rather, second interface 104 may re-route a portion of the illegitimate packets to special destination 112, and discard other illegitimate packets not re-routed. Further, in various embodiments, illegitimate packets awaiting re-routing by second interface 104 may be placed in an illegitimate packet queue and scheduled for transmission at the second one or more routing rates, which, as mentioned, is in some embodiments a maximum bandwidth.

As illustrated, once routed or re-routed, packets are transmitted by router 100 across networking fabric 116 to their destinations 110 and/or special destinations 112. In various embodiments, such as those shown, networking-fabric 116 is an enterprise WAN. Both legitimate and illegitimate packets may be routed and/or re-routed across such an enterprise WAN. In other embodiments, however, networking fabric 116 may be a LAN, the Internet, or some other public network. These LAN, WAN, and/or other networks may be implemented through TCP/IP connections, or in other embodiments, may be implemented as any other sort of connection known in the art.

As is further shown, one or more packet destinations 110 may receive legitimate packets that have been routed to them from router 100 across networking fabric 116. The packet destinations 110 may be any sort of router, computing environment, or computing device known in the art, such as a PC, a workstation, a server, an embedded system, a mobile phone, a PDA, or the like. If a router, packet destination 110 may be a WAN router like router 100 providing WAN connectivity to a LAN. Such a router may even have interfaces like those of router 100, the interfaces capable of receiving packets, analyzing the packets to determine if the packets are legitimate, and routing or re-routing the packets in the same fashion as router 100. Thus, in some embodiments, a router may perform the operations of router 100 at some times and of a packet destination 110 at other times.

As is further illustrated, one or more special destinations 112 may receive illegitimate packets from router 100 via networking fabric 116 for analysis or disposition by the special destinations 112. Additionally, in various embodiments, special destinations 112 may comprise one or more secure sub-networks, the secure sub-networks capable of facilitating analysis and disposition of the illegitimate packets, as well as capable of preventing the packets' further outbound spread. Optionally, and as shown, special destination 112 may comprise a secure sub-network having a plurality of security tools 114 capable of analyzing the illegitimate packets. These tools may be any one or more security tools that are commonly known in the art, such as a sniffer, a worm hunter, a tarpit, a honeypot, or a network intrusion detection system. Security tools 114 might also contain one or more custom, proprietary tools designed for use in the analysis of illegitimate packets received from a router 100 of an enterprise WAN. In some embodiments, then, special destinations 112 may use security tools 114 to analyze and characterize the illegitimate packets (as a virus, a worm, etc.), and thus facilitate the enterprise having the enterprise WAN 116 and router 100 in taking appropriate action to deal with the threat posed by the illegitimate packet.

Further, in a series of embodiments not illustrated, the one or more special destinations may be connected to the enterprise WAN/networking fabric 116 via an ATM (asynchronous transfer mode) virtual connection. Such a connection may be made between the special destinations 112 and a WAN router providing the special destinations 112 with connectivity to the enterprise WAN 116. However, special destinations 112 need not utilize an ATM virtual connection to achieve connectivity to the enterprise WAN 116. Some other connection known in the art, such as a TCP/IP connection, may be used just as readily to provide connectivity.

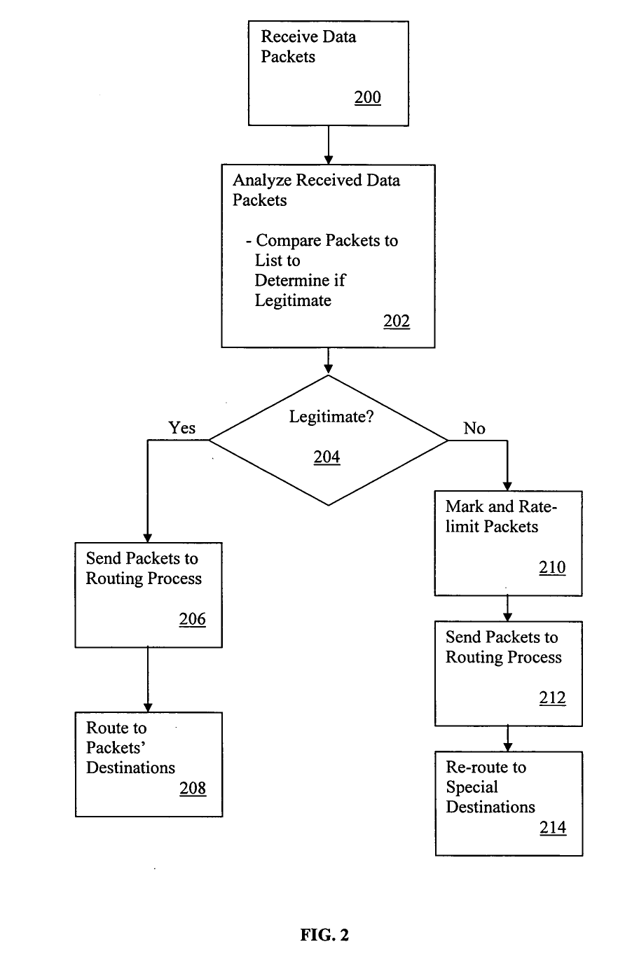

FIG. 2 illustrates a flow chart view of selected operations of the methods of various embodiments of the present invention. As illustrated, a first one or more interfaces 102 of router 100 may receive a plurality of data packets from one or more computing environments 106, block 200. The computing environments 106 may be connected to router 100 via a networking fabric 108, such as a LAN. Router 100 may serve as a WAN router for such a LAN, providing WAN access to computing environments 106 of the LAN. In other embodiments, router 100 may serve as a LAN router for the LAN. Also, as described above, first interface 102 may be implemented as one or more ports of router 100, providing connectivity between router 100 and networking fabric 108. The computing environments may be any sort of computing environment known in the art, such as PCs, workstations, servers, embedded systems, modile phones, PDAs, and the like. The LAN connections of networking fabric 108 may be implemented via the TCP/IP protocol, although in some embodiments may be implemented as any other sort of connection known in the art.

Upon receiving the data packets, first interface 102 of router 100 may proceed to analyze the packets to determine whether each of the packets is legitimate or illegitimate, block 202. In some embodiments, the analysis may comprise comparing each of the plurality of data packets to a list of legitimate destinations, the list of legitimate destinations comprising a list of legitimate addresses for a wide area network of an enterprise. The list of legitimate destinations, in some embodiments referred to as an access list, may contain all addresses within a global enterprise WAN to which packets may be routed. The list may in other embodiments, however, contain, less, more, or different addresses to which packets may be sent. As referred to in this series of embodiments, an “address” is a unique identifying value for every router and computing device having access to a network. This address may be the same as the IP address commonly used to identify computers on a LAN, a WAN, or the Internet, or may be some other address. As shown here, the list contains addresses for computing devices connected to an enterprise WAN, either directly or through a WAN router such as router 100. Packets having as a destination address an address contained by the list, may, in some embodiments be considered legitimate, while those having a destination address not contained by the list may be considered illegitimate. In other embodiments not shown, first interface 102, may, as part of the comparison, determine if the addresses of the access list share an address space (for purposes of this series of embodiments, an address space may be understood as a portion of the address value that is the same for all addresses of a specific group). For example, all addresses on a list of legitimate destinations may share “179” as part of their address values (e.g., 179.010.345.002). If all or some of the addresses on the access list share an address space, and first interface 102 receives a packet sharing that address space but not on the access list, first interface 102 may consider the packet either legitimate or illegitimate, based on preferences such as those discussed above. Further, in some embodiments, comparison to a list may be facilitated by associating the list with a routing class map, associating the routing class map with an IP marking policy map, and then applying the IP marking policy map to the received packets at first interface 102.

As is also illustrated, if one or more data packets of the received plurality of packets are determined to be legitimate, block 204, first interface 102 may immediately send the legitimate packets to the routing process of router 100, block 206, where the packets may follow the default routing path to the second one or more interfaces 104 for transmission.

Upon reaching second interface 104, second interface 104 may ascertain whether or not the packets are legitimate (not shown). In other embodiments, as described above, second interface 104 may be implemented as a plurality of interfaces, some routing legitimate packets, others re-routing illegitimate packets. In such embodiments, no ascertainment of legitimacy would be necessary. If second interface 104 seeks to ascertain legitimacy of the packets, it may do so by reading the packets' DSCP values. If the DSCP value of the packets has not been set to a specified value, as discussed above, the packets may be routed to their destinations 110 through networking fabric 116, block 208. Legitimate packets may be routed to their destinations 110 at a higher one or more routing rates than illegitimate packets are re-routed to their one or more special destinations 112. In some embodiments, this may consist simply of routing the legitimate packets at the routing rate commonly used by router 100 in routing packets. The second one or more routing rates at which illegitimate packets are re-routed may consist of some maximum bandwidth, such as ten packets per second.

As is further illustrated, if one or more data packets of the received plurality of packets are determined to be illegitimate, block 204, first interface 102 may then mark and rate-limit packets considered illegitimate, block 210. Such packets may be “marked” by setting the DSCP value of each packet in that packet's header, the meaning of “DSCP” and “packet header” discussed above. For example, if the illegitimate packet had its DSCP value set for high priority services, first interface 102 may reset the DSCP to a different, specified value. In some embodiments this may consist simply of setting the DSCP value to that commonly used to indicate to routers a request for lower priority service. In this way, transmission of illegitimate packets may be rate-limited to a maximum bandwidth.

After “marking” illegitimate packets by, in some embodiments, setting their DSCP values, block 210, first interface 102 may then send the illegitimate packets to a routing process of router 100, block 212, where the packets may follow the default routing path to the second one or more interfaces 104 for transmission.

Upon reaching second interface 104, second interface 104 may ascertain whether or not the packets are illegitimate (not shown). In other embodiments, as described above, second interface 104 may be implemented as a plurality of interfaces, some routing legitimate packets, others re-routing illegitimate packets. In such embodiments, no ascertainment of illegitimacy would be necessary. If second interface 104 seeks to ascertain illegitimacy of the packets, it may do so by reading the packets' DSCP values. Illegitimate packets may have been marked as such by the first interface 102, first interface 102 having set the DSCP value of the illegitimate packets to a specified value, such as that commonly used to indicate to routers a request for lower priority service.

As is further illustrated, upon receipt and/or ascertainment of illegitimate packets, those packets may be re-routed to one or more special destinations 112 for analysis or disposition at a second one or more routing rates that is lower than the first one or more routing rates at which legitimate packets may have been routed, block 214. In some embodiments, this second one or more routing rates may consist of a maximum bandwidth value, such as ten packets per second. In re-routing the illegitimate packets, second interface 104 may reset the destination address of the packets contained in the packets' headers to an address of the one or more special destinations 112. By resetting the destination address of the illegitimate packets, second interface 104 allows the illegitimate packets to be sent through intermediate, relaying routers of the networking fabric 116 to the one or more special destinations 112. In various embodiments, however, second interface 104 need not reset the destination address of the illegitimate packets in sending them to their special destinations 112. Instead, second interface 104 may simply establish a connection to the special destinations 112 across the networking fabric 116, sending the illegitimate packets directly to the special destinations 112. In some embodiments, second interface 104 need not re-route all illegitimate packets. Rather, second interface 104 may re-route a portion of the illegitimate packets to special destination 112, and discard other illegitimate packets not re-routed. Further, in various embodiments, illegitimate packets awaiting re-routing by second interface 104 may be placed in an illegitimate packet queue and scheduled for transmission at the second one or more routing rates, which, as mentioned, is in some embodiments a maximum bandwidth.

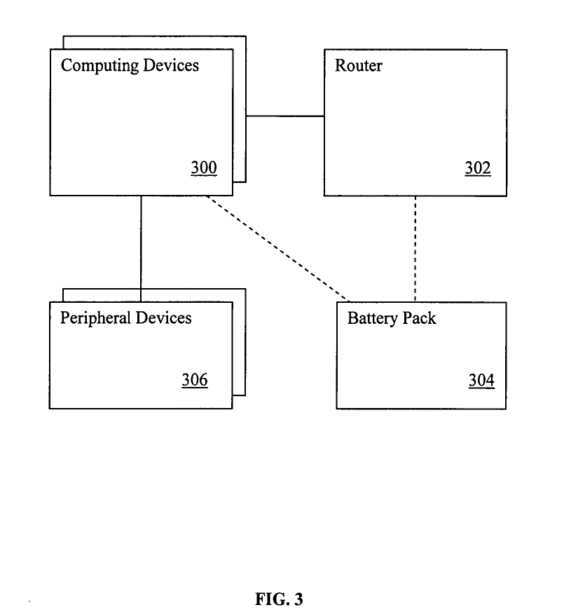

FIG. 3 illustrates a system view of embodiments of the present invention, the system having a backup battery pack coupled to selected one or ones of the computing devices and router. As illustrated, a plurality of computing devices 300 having associated peripheral devices 306 is coupled to a router 302. The computing devices 300 may be any sort of computing devices known in the art, such as PCs, workstations, servers, embedded systems, routers, mobile phones, PDAs, and the like. Referring to FIG. 1, computing device 300 may represent any one or more of computing environments 106, packet destinations 110, and special destinations 112, or may represent some other computing device coupled to router 302 not illustrated by FIG. 1.

Further referring to FIG. 1, router 302 may represent router 100, or may represent some other router not illustrated in FIG. 1 that is coupled to computing devices 300. As shown, router 302 receives a plurality of data packets from computing devices 300, analyzes each of the received data packets to determine whether the packet should be considered legitimate or illegitimate, and routes the legitimate packets to the legitimate packets' destinations at first one or more routing rates, and re-routes the illegitimate packets to one or more special destinations for further analysis or disposition at second one or more routing rates that are lower than said first one or more routing rates. The details of these operations are illustrated in FIGS. 1 and 2 and described above in greater detail.

Additionally, as shown, router 302 is coupled to the computing devices 300. Referring to FIG. 1 and it above description, such coupling may be represented by the connection of router 100 to computing environments 106 across networking fabric 108, may be represented by the connection of either or both of packet destinations 110 and/or special destinations 112 to router 100 across networking fabric 116, or may be represented by some other sort of connection not shown. Though, as illustrated, networking fabric 108 represents a LAN and networking fabric 116 represents a WAN, either networking fabric may represent a LAN, a WAN, the Internet, or some other network known in the art. In various embodiments, the connection or connections coupling router 302 to computing devices 300 may be TCP/IP connections, but may be any other sort of connection known in the art. For example, in some embodiments, computing devices 300 may be coupled to router 302 via an ATM virtual connection, as described above in reference to the connection between router 100 and special destinations 112.

Also, in various embodiments, the computing devices 300 may have a plurality of associated peripheral devices 306. Such peripheral devices 306 may include mouses, keyboards, display monitors, joysticks, printers, modems, routers, batteries, and other peripheral devices known in the art.

The system illustrated by FIG. 3 includes a backup battery pack 304 coupled to selected one or ones of the computing devices 300 and router 302 to provide backup power to the coupled one or ones of the computing devices 300 and router 302. As shown, the backup battery pack 304 may be coupled to either or both of computing devices 300 and/or router 302. The backup battery pack 304 may be of any kind known and used in the art, and may be coupled to either or both via power cords.

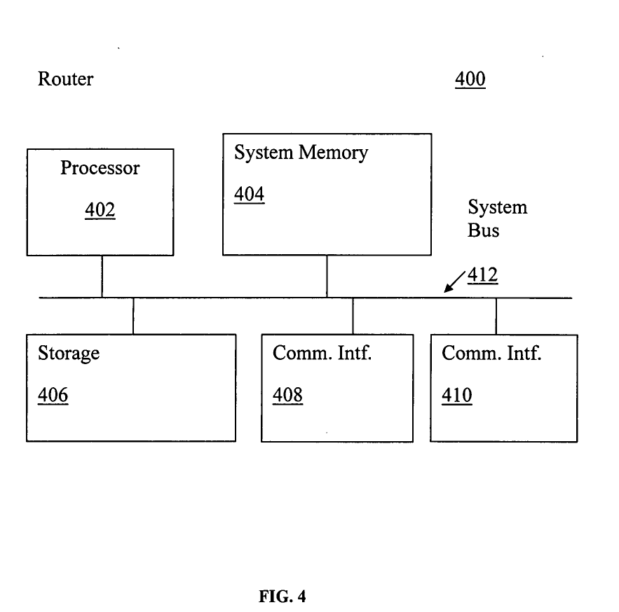

FIG. 4 illustrates an example router suitable for use to practice various embodiments of the present invention. As shown, router 400 includes one or more processors 402 and system memory 404. Additionally, router 400 includes persistent storage 406 and communication interfaces 408 and 410. The elements are coupled to each other via system bus 412, which represents one or more buses. In the case of multiple buses, they are bridged by one or more bus bridges (not shown). Each of these elements performs its conventional functions known in the art. In particular, system memory 404 and storage 406 are employed to store a working copy of the traffic managing processes and a permanent copy of the programming instructions implementing the traffic managing processes, respectively. The permanent copy of the instructions implementing the traffic managing processes may be loaded into storage 406 in the factory, or in the field, through a distribution medium (not shown) or through one of communication interfaces 408 and 410. The constitution of these elements 402-412 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
receiving a plurality of data packets from one or more computing environments;
analyzing each of the received data packets to determine whether the packet should be considered legitimate or illegitimate; and
routing the legitimate packets to the legitimate packets' destinations at first one or more routing rates, and re-routing the illegitimate packets to one or more special destinations for further analysis or disposition at second one or more routing rates that are lower than said first one or more routing rates.

2. The method of claim 1, further comprising, if one or more packets of the plurality of data packets are illegitimate, marking the one or more illegitimate packets.

3. The method of claim 1, wherein the illegitimate packets comprise at least one of the group consisting of a worm, a virus, and a denial of service attack.

4. The method of claim 1, wherein the receiving comprises receiving a plurality of data packets from one or more computing environments of a local area network.

5. The method of claim 1, wherein the analyzing comprises comparing a destination of each of the plurality of data packets to a list of legitimate destinations, the list of legitimate destinations comprising a list of legitimate addresses for a wide area network of an enterprise.

6. The method of claim 1, wherein the routing of the legitimate packets comprises routing the legitimate packets across a wide area network, and the re-routing of the illegitimate packets comprises re-routing the illegitimate packets across a wide area network.

7. The method of claim 1, wherein the re-routing comprises re-routing the illegitimate packets to one or more secure sub-networks accessible via a wide area network, the secure sub-networks having at least one security monitoring tool from the group consisting of a sniffer, a worm hunter, a tarpit, a honeypot, and a network intrusion detection system.

8. A router comprising:
a first one or more interfaces adapted to
receive a plurality of data packets from one or more computing environments,
analyze each of the received data packets to determine whether the packet should be considered legitimate or illegitimate; and
a second one of more interfaces adapted to route the legitimate packets to the legitimate packets' destinations at first one or more routing rates, and re-route the illegitimate packets to one or more special destinations for further analysis or disposition at second one or more routing rates that are lower than said first one or more routing rates.

9. The router of claim 8, wherein the router further includes a processor adapted to operate at least the first or the second one or more interfaces.

10. The router of claim 9, wherein both the first and the second one or more interfaces are operated by the processor and the router further includes a storage medium storing first and second pluralities of programming instructions correspondingly implementing the first and the second one or more interfaces.

11. The router of claim 8, wherein the first one or more interfaces is further adapted to, if one or more packets of the plurality of data packets are illegitimate, mark the one or more illegitimate packets.

12. The router of claim 8, wherein the illegitimate packets comprise at least one of the group consisting of a worm, a virus, and a denial of service attack.

13. The router of claim 8, wherein the one or more computing environments are located within a local area network, the router serving as a wide area network access point for the local area network.

14. The router of claim 8, wherein the analyzing is facilitated by a list of legitimate destinations, said list comprising a list of legitimate addresses for a wide area network of an enterprise, the router serving as an access point to the wide area network.

15. The router of claim 8, wherein the second one or more interfaces is adapted to route the legitimate packets to the legitimate packets' destinations at first one or more routing rates, and re-route the illegitimate packets to one or more special destinations for further analysis or disposition at second one or more routing rates that are lower than said first one or more routing rates, said routing and re-routing comprising routing and re-routing across a wide area network.

16. The router of claim 8, wherein the one or more special destinations are one or more secure sub-networks accessible via a wide area network, the secure sub-networks having at least one security monitoring tool from the group consisting of a sniffer, a worm hunter, a tarpit, a honeypot, and a network intrusion detection system.

17. An article of manufacture comprising:
a storage medium having stored therein a plurality of programming instructions designed to program a router, which when executed enable the router to
receive a plurality of data packets from one or more computing environments;
analyze each of the received data packets to determine whether the packet should be considered legitimate or illegitimate; and
route the legitimate packets to the legitimate packets' destinations at first one or more routing rates, and re-route the illegitimate packets to one or more special destinations for further analysis or disposition at second one or more routing rates that are lower than said first one or more routing rates.

18. The article of manufacture of claim 17, wherein the plurality of programming instructions, when executed, further enable the router to, if one or more packets of the plurality of data packets are illegitimate, mark the one or more illegitimate packets.

19. The article of manufacture of claim 17, wherein the illegitimate packets comprise at least one of the group consisting of a worm, a virus, and a denial of service attack.

20. The article of manufacture of claim 17, wherein the plurality of programming instructions, when executed, further enable the router to receive a plurality of data packets from one or more computing environments, and the one or more computing environments are located within a local area network, the router serving as a wide area network access point for the local area network.

21. The article of manufacture of claim 17, wherein the plurality of programming instructions, when executed, further enable the router to analyze each of the received data packets to determine whether the packet should be considered legitimate or illegitimate, the analysis comprising, at least in part, comparing a destination of each of the plurality of data packets to a list of legitimate destinations, the list of legitimate destinations comprising a list of legitimate addresses for a wide area network of an enterprise.

22. The article of manufacture of claim 17, wherein the plurality of programming instructions, when executed, further enable the router to route the legitimate packets to the legitimate packets' destinations at first one or more routing rates, and re-route the illegitimate packets to one or more special destinations for further analysis or disposition at second one or more routing rates that are lower than said first one or more routing rates, said routing and re-routing comprising routing and re-routing across a wide area network.

23. The article of manufacture of claim 17, wherein the plurality of programming instructions, when executed, further enable the router to re-route the illegitimate packets to one or more special destinations, and the one or more special destinations are one or more secure sub-networks accessible via a wide area network, the secure sub-networks having at least one security monitoring tool from the group consisting of a sniffer, a worm hunter, a tarpit, a honeypot, and a network intrusion detection system.

24. A system comprising:
a plurality of computing devices having associated peripheral devices;
a router coupled to the plurality of computing devices to receive a plurality of data packets from the computing devices, analyze each of the received data packets to determine whether the packet should be considered legitimate or illegitimate, and route the legitimate packets to the legitimate packets' destinations at first one or more routing rates, and re-route the illegitimate packets to one or more special destinations for further analysis or disposition at second one or more routing rates that are lower than said first one or more routing rates; and
a backup battery pack coupled to selected one or ones of the computing devices and router to provide backup power to the coupled one or ones of the computing devices and router.

25. The system of claim 24, wherein the router is adapted to analyze each packet by comparing a destination of each of the plurality of data packets to a list of legitimate destinations, the list of legitimate destinations comprising a list of legitimate addresses for a wide area network of an enterprise.

26. The system of claim 24, wherein the router is adapted to route the legitimate packets across a wide area network, and re-route the illegitimate packets across the wide area network.
